(19) United States
(12) Patent Application Publication
(10) Pub. No.: US 2014/0203200 A1
(43) Pub. Date: Jul. 24, 2014

(54) DEVICE FOR DETECTING THE STATE OF A MOUNTING OF A COIL ON AN ELECTROVALVE

(71) Applicant: ERA-SIB, Argenteuil (FR)

(72) Inventor: Almiro DA SILVA, LONGNES (FR)

(21) Appl. No.: 14/163,011

(22) Filed: Jan. 24, 2014

(30) Foreign Application Priority Data
Jan. 24, 2013 (FR) 1350628

(51) Int. Cl. F16K 31/06

(52) U.S. Cl. CPC F16K 31/0655
USPC 251/129.15

(57) ABSTRACT

The invention relates to a device for detecting a state of a mounting of an electrovalve head on a support of a body of an electrovalve, said head comprising a coil.

According to the invention, the device comprises at least one element made on the head and cooperating with the body of the electrovalve.

### TECHNICAL FIELD

The present invention relates to the field of electrovalves.

More particularly, the invention relates to a device for detecting the state of mounting of an electrovalve head, comprising a coil, on an electrovalve body.

### BACKGROUND

It is known, for example in respect of managing the filling of a washing machine tub or within an air-conditioning system, to implement one or more electrovalves.

As illustrated in FIG. 1, an electrovalve 100 is, in a conventional manner, composed mainly of two parts, namely an electrovalve body 300 and a head 200, otherwise called a magnetic head. The electrovalve body 300 comprises inter alia joining orifices 310, 320 making it possible to circulate a fluid, as well as means for monitoring the flow of the fluid at the level of these two orifices 310, 320. This electrovalve body 300 furthermore comprises a guidance tube, made starting from an external face of the body, and making it possible to fix the magnetic head 200 to the body of the electrovalve. This magnetic head 200 comprises inter alia a housing enclosing a coil composed of copper wires wound around a metallic core, the core forming the iron circuit and the wires the copper circuit of the coil. The magnetic head 200 furthermore comprises three terminals, namely a positive terminal 220, a negative terminal 230 and an earth terminal 210, these terminals making it possible to supply the magnetic head with electricity.

The head 200 is held fixed on a support (not represented) of the body 300 of the valve by fixing means such as a nut 240 cooperating with a threaded part of the support, which here is a guidance tube, so that the head 200 is no longer mobile in translation with respect to the body of the valve.

For the proper operation of the electrovalve, the coil, and consequently the head of the valve, must fulfill several criteria, namely be present, be fixed correctly on the support of the body of the electrovalve, and be in a “working state”, that is to say not have failed.

However, at the present time, there exist only some devices making it possible to verify the integrity of the coil. Thus, such devices do not make it possible to determine satisfactorily whether or not the coil is in a state to operate, this being unsatisfactory.

Indeed a head which were, for example, poorly fixed on the support of the body of the valve would not be fully effective, this being unsatisfactory.

Moreover, a head which were mounted the wrong way round on the body of the valve, that is to say a coil which were to provide a magnetic field opposite to the magnetic field envisaged for the proper operation of the electrovalve, would not allow the electrovalve to fulfill its function, this also being unsatisfactory.

Furthermore, a coil which were not present would obviously not allow the electrovalve to operate appropriately.

### BRIEF SUMMARY

The invention seeks to solve the drawbacks of the prior art.

More particularly the invention provides a device making it possible to ascertain the state of the mounting of an electrovalve head on a support of a body of an electrovalve so as to be certain of the proper mounting of the coil and thus of the “proper operation” of this electrovalve.

to the invention further provides such a device which is adaptable to most, or indeed all, presently existing types of electrovalves.

The invention further provides a device which is inexpensive and simple to implement.

More specifically, the invention provides a device for detecting a state of a mounting of an electrovalve head on a support of a body of an electrovalve, the head comprising a coil. According to the invention, the device comprises at least one element made on the head and cooperating with the body of the electrovalve.

Thus, the invention proposes a new and inventive approach making it possible to determine the state of mounting of an electrovalve head on an electrovalve body support, and consequently of the state of mounting of the coil housed in the head. This thus makes it possible to have information on the state of mounting of the head (and therefore of the coil), and consequently on the capacity of the electrovalve to be able to fulfill its function.

In a particular embodiment of the invention, the element cooperates electrically and/or magnetically with the body of the valve.

Thus, this makes it possible to detect, by way of electrical and/or magnetic data, a state of mounting of the head on the support. Indeed, the element cooperating electrically and/or magnetically with the body of the valve, an electric and/or magnetic field is detectable and possesses a characteristic value as a function of its mounting state.

In another embodiment of the invention, the element comprises at least one first electrical earth terminal made on the head of the valve, and linked to a second electrical earth terminal made on the body of the valve, the first and second terminals forming an earth circuit.

This makes it possible to form an electrical circuit between the head of the valve and the body of the valve and thus to be able to detect the state of the mounting of the head of the valve on the support by way of this electrical circuit.

In this case, the device can comprise continuity monitoring means for the earth circuit such as an ohmmeter or a conductivity meter.

This makes it possible to detect the state of the mounting of the electrovalve head on the support by monitoring the continuity of the earth circuit between the head and the valve. Therefore, it is possible to detect a defect of mounting through the earth circuit being open, detected by the monitoring means.

In a variant, the first and second earth terminals are linked by way of at least one plug-in connector comprising screw-on terminals or crimp-on lugs.

Such a connector makes it possible to secure the continuity of the circuit by limiting the risk of breakage between the two terminals of the circuit.

In another embodiment, the element comprises at least one magnet housed in the head and cooperating with at least one magnetic sensor fixed on the body of the valve.

Thus, this makes it possible to implement an element generating a magnetic field on the head of the coil, and cooperating with a sensor, implemented on the body of the valve, able to measure a value characteristic of the magnetic field generated. It is therefore possible to detect a defect of mounting of the head of the valve on the support by sensing this magnetic field.

In this case, the magnet can be housed in the head, in proximity to a zone of contact between the head and the support of the body of the valve.

Therefore, it is possible to precisely detect the magnetic field generated by the magnet by disposing it in proximity to the sensor.

In a particular embodiment, the magnet exhibits an annular profile.

Thus, in this way the magnetic field to be sensed by the sensor implemented on the body of the valve can be made homogeneous.

The invention also relates to an electrovalve comprising a device according to one of the embodiments of the invention.

### BRIEF DESCRIPTION OF THE DRAWINGS

Other characteristics and advantages of the invention will more clearly appear on reading the following description of two embodiments, given by way of simple illustrative and nonlimiting examples, and the appended drawings, among which:

FIG. 1, already presented previously, is a perspective view of an electrovalve of the prior art;

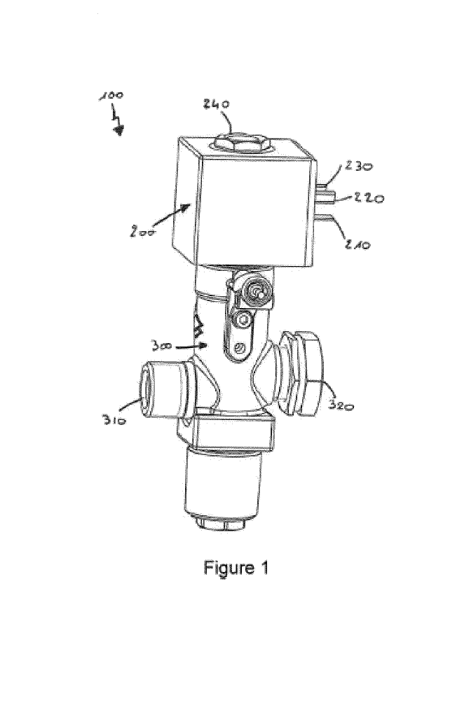

FIG. 2 is a sectional lateral view of an electrovalve comprising a detection device according to a first embodiment of the invention;

FIG. 3 is a sectional lateral view of an electrovalve comprising a detection device according to a second embodiment of the invention; and

FIG. 4 is a sectional lateral view of the magnetic head of FIG. 3.

### DETAILED DESCRIPTION

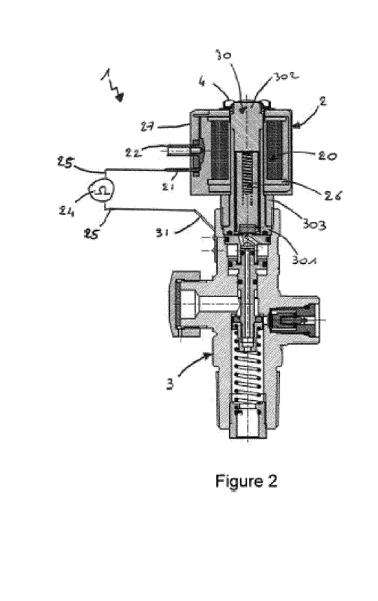

A first embodiment of the invention is now presented in conjunction with FIG. 2. As illustrated in this figure, the electrovalve 1 comprises a valve head 2 and a valve body 3.

The valve head 2 comprises a coil 20 composed of copper wires 28 wound around a plastic hollow socket 26, slipped into a metallic stirrup 29, the stirrup 29 forming the iron circuit and the wires 28 the copper circuit of the coil 20. The magnetic head 2 furthermore comprises a casing 27, which is in this example substantially parallelepipedal, making it possible to house the coil 20 inside the magnetic head 2. This coil 20 is linked to three electrical terminals, namely a positive terminal 22, a negative terminal (not visible in this figure), and an earth terminal 21. These three terminals are mounted in proximity to one of the faces of the casing 27 so that they are made in part outside this casing 27. Provision may very obviously be made for a casing exhibiting a profile different from a parallelepipedal profile. It is in particular possible to implement a cylindrical, cubic, or spherical casing.

The head 2 is mounted on the body 3 of the valve by way of a support 30, belonging to the body 3. This support 3 comprises a metallic guidance tube 301 cooperating with the socket 26, so as to guide the mounting of the head 2. The support 30 furthermore comprises a metallic abutment 303 on which the head 2 bears when it is in the configuration of use, and a yoke 302 cooperating with one or more means 4 for locking the position of the magnetic head 2, this means here being a clamping nut clamping the magnetic head 2 against the abutment 303 of the support so that it is held in place.

So as to detect and to verify the state of mounting of the head 2, and indirectly of the coil 20, a device for detecting the state of the mounting of the head on the support of the body of the valve is disposed on the electrovalve 1. This device comprises an element made on the magnetic head 2, namely the earth terminal 21, which cooperates electrically with the body 3 of the valve by way of a terminal 31 disposed on the exterior contour of the body 3. In this example, the two earth terminals 21, 31 are linked together by way of a plug-in connector 25 with screw-on terminals or crimp-on lugs, so as to form a continuous earth circuit between the coil 20 (and consequently the head 2) and the body 3 of the electrovalve 1. Thus, the earth circuit is closed between the coil and the body of the valve only if the coil is mounted on the support of the valve, if the clamping nut 4 is present so as to ensure permanent contact between the head 2 and the body 3, and if the two earth terminals 21, 31 are linked together. The device for detecting the state of mounting of the electrovalve head 2 on the support 30 therefore makes it possible to detect several defects of mounting of the head 2 on the support 30, among which:
a defect of presence of the coil 20 and/or of the head 2 which causes cutting of the earth circuit between the abutment 303 and the body 3 of the valve;
a defect of connection of the earth terminals 21, 31 which causes cutting of the earth circuit between the connector 25 and the coil 20; or
a defect of presence of the clamping nut 4 which causes opening of the circuit between the coil 20 and the body 3 of the valve.

So as to detect at least one of these defects, corresponding to a “break in the continuity” of the earth circuit, corresponding therefore to one of the aforementioned defects at the level of the electrovalve, the device furthermore comprises, in this embodiment, means 24 for monitoring the continuity of the circuit such as an ohmmeter or a conductivity meter.

According to several variants of the invention, it may be contemplated that the aforementioned mounting defects are detected, by the detection device, differently or not. Stated otherwise, provision may be made for monitoring means which signal a break in the continuity of the earth circuit, making it possible simply to detect a mounting defect without further detail about the nature of the defect. Provision may also be made for monitoring means which signal a break in the continuity of the earth circuit as well as an indication of the earth circuit part at the level of which the breakage is effective, making it possible to deduce the nature of the mounting defect, namely if this is a defect of presence, of connection, or of clamping.

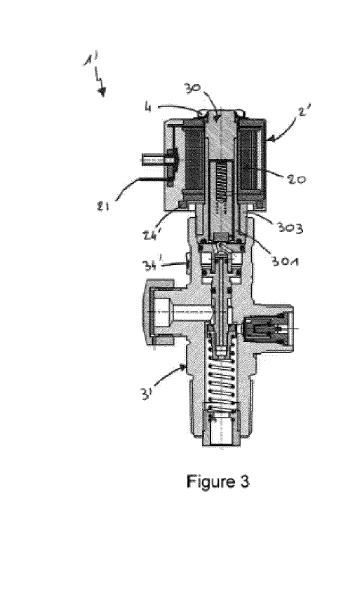

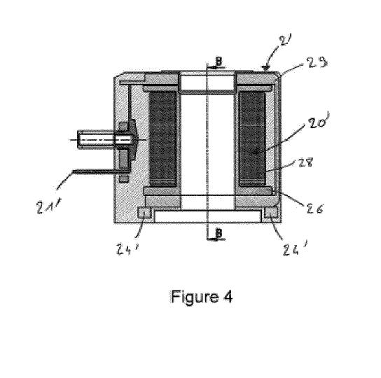

A second embodiment of the invention is now presented in conjunction with FIGS. 3 and 4.

In this embodiment, the detection device implemented within the electrovalve 1′ also comprises an element made on the head 2′ and cooperating magnetically with the body 3′ of the electrovalve, in the form of a magnet 24′ housed in the head 2′ and cooperating with a magnetic sensor 34′ fixed on the exterior contour of the body 3′ of the valve. According to the variants of the invention, provision may be made for the magnet to be molded or overmolded in the casing enclosing the coil. Provision may furthermore be made for a coil molded or otherwise in the casing, and independently a magnet molded or otherwise in the casing.

In this example, the magnet 24′ exhibits an annular profile and is housed in the head 2′, in proximity to a zone of contact between the head 2′ and the support 30, that is to say in proximity to the annular abutment 303 similar to the abutment implemented in the first embodiment illustrated in FIG. 2. As illustrated in FIG. 3, the magnet 24′ is housed in such a way that it is coaxial with the guidance tube 301 of the support 30.

The magnetic sensor 34′ detects the magnetic field of the magnet 24′ thereby making it possible to detect a state of mounting of the magnet 24′, and consequently of the head 2′ and of the coil 20. Indeed, the sensor can detect a magnetic field in accordance with expectations, reverse to the expected magnetic field, of different value to the expected value, or even an absence of magnetic field. Thus, this detection device will, in this second embodiment, be able to detect several defects of mounting of the head 2′ of the valve on the support 30 of the body 3′, among which:
an absence of magnetic field, which may signify the non-presence of the magnetic head 2′ or of the magnet 24′ in the head 2′;
a different, or indeed variable, magnetic field value which may be due to poor clamping of the magnetic head 2′ on the guidance tube 301 of the support, or to absence of the clamping nut 4 for example; or
a magnetic field to the expected magnetic field which may be a sign of a mounting of the head 2′ on the support 30 the wrong way round.

Just as for the first embodiment presented hereinabove, it is possible to contemplate several variants of the invention, in which the aforementioned mounting defects are detected, by the detection device, differently or not.

Thus, a possibility of “proper operation” or otherwise of the electrovalve is ensured, from the standpoint of the mounting of the coil on the support, by detecting the state of the mounting of the head on the support, which is a condition of the proper operation of the electrovalve.

In variants of the invention, provision may be made for embodiments in which the magnet were to exhibit a different profile and were not housed at the same site as the magnet of the embodiment presented. For example, it is possible to contemplate embodiments in which the magnet were simply a parallelepipedal magnet placed in a location inside the magnetic head and detected in the same manner by the magnetic sensor of the body of the valve. It is also possible to contemplate several elements disposed in or on the head of the valve and cooperating magnetically with one or more magnetic sensors disposed on or in the body of the valve.

Provision may also be made for embodiments in which the detection device comprises one or more elements made on the head and cooperating both electrically and magnetically with the body of the valve, or even a combination of elements cooperating electrically and of elements cooperating magnetically.

1. Device for detecting a state of a mounting of an electrovalve head on a support of a body of an electrovalve, said head comprising a coil, that the device comprising at least one element made on the head and cooperating with the body of the electrovalve.

2. Device according to claim 1, wherein the element cooperates electrically and/or magnetically with the body of the electrovalve.

3. Device according to claim 1, wherein the element comprises at least one first electrical earth terminal made on the head of the valve, and linked to a second electrical earth terminal made on the body of the valve, said first and second terminals forming an earth circuit.

4. Device according to claim 3, wherein it comprises continuity monitoring means for the earth circuit.

5. Device according to claim 3, wherein said first and second earth terminals are linked together by way of at least one connector.

6. Device according to claim 1, wherein the element comprises at least one magnet housed in the head and cooperating with at least one magnetic sensor fixed on the body of the valve.

7. Device according to claim 6, wherein the magnet is housed in the head, in proximity to a zone of contact between the head and the support of the body of the valve.

8. Device according to claim 6, wherein the magnet exhibits an annular profile.

9. Electrovalve comprising a valve head able to be mounted on a support of an electrovalve body, said valve head comprising a coil, the electrovalve further comprising a device for detecting the state of the mounting of the valve head on the support according to claim 1.
